(19) United States
(12) Patent Application Publication
(10) Pub. No.: US 2010/0073105 A1
(43) Pub. Date: Mar. 25, 2010

(54) PHASE SHIFTER

(76) Inventors: Dau-Chyrh CHANG, Taipei City (TW); Bing-Hao Zeng, Dali City (TW); Ji-Chyun Liu, Dasi Township (TW)

Correspondence Address: RABIN & Berdo, PC, 1101 14TH STREET, NW, SUITE 500, WASHINGTON, DC, 20005, US

(21) Appl. No.: 12/235,701

(22) Filed: Sep. 23, 2008

(51) Int. Cl. H01P 1/18

(52) U.S. Cl. 333/161; 333/136

(57) ABSTRACT

A phase shifter including a substrate, a plurality of first transmission lines, a plurality of second transmission lines, and a coupling portion is described. After the phase shifter feeds a signal into the first transmission lines, the first transmission lines assign the signal to the second transmission lines. Moreover, the coupling portion moves to change an area of the second transmission lines shielded by the coupling portion, so as to change the phase of the signal transferred by each of the second transmission lines.

### BACKGROUND OF THE INVENTION

1. Field of the Invention

The present invention relates to a phase shifter. More particularly, the present invention relates to a phase shifter having a movable coupling portion.

2. Related Art

With the development of wireless communication technology, wireless communication products are playing an increasingly important role in people's daily life. Meanwhile, the demands on the communication products have been transited from mere voice and message transmission in the past to image transmission, online browsing, and so on. Moreover, the products are required to be light, thin, short, small and provided with various types of communication services, instead of neglecting the appearance in the past. The current situation shows that the communication products are developing towards broadband and multiplexing integration. Therefore, antennae used for transmitting/receiving signals must have a wide bandwidth, so as to achieve a high transmission speed and provide multiple communication services.

Phase shifters, generally used in the fields such as communication, gauging instruments, and control, can be widely applied, but also have many problems to be solved. For example, a type of phase shifter applicable to various base station antennae is still in need; the signal coupling efficiency is low due to the structure of the metal material; different phases cannot be output simultaneously, and the phase of an output signal can only be changed at a single output portion under the control of a phase shifter; or noises are generated during the phase shift in a contact signal transmission mode. In addition, the common phase shifters all have a huge size, and are complicated to fabricate due to the metal structures thereof.

### SUMMARY OF THE INVENTION

Accordingly, the present invention is directed to a phase shifter, so as to solve the above problem that different phases cannot be output simultaneously and meanwhile eliminate noises generated during the phase shift by adopting a non-contact signal transmission mode.

A phase shifter including a substrate, a plurality of second transmission lines, a coupling portion, and a plurality of output portions is provided. The substrate is formed with a plurality of first transmission lines and an input portion, in which the first transmission lines are respectively coupled to the input portion, for transmitting a signal received by the input portion. The second transmission lines are formed on the substrate, and each has a first end electrically connected to one of the first transmission lines correspondingly. The coupling portion, disposed corresponding to and moving relative to the second transmission lines to change an area of the second transmission lines shielded by the coupling portion, is used for coupling the signal received by each of the second transmission lines, so as to change the phase of the signal transmitted by each of the second transmission lines. Each of the output portions is electrically connected to a second end of each of the second transmission lines, for receiving the signal output by the corresponding second transmission line.

The phase shifter of the present invention further includes a plurality of power distribution units electrically connected to the plurality of first transmission lines, so as to assign the signal received by the input portion to the first transmission lines for transmission.

In the phase shifter of the present invention, the coupling portion is a step-like dielectric plate formed by connecting a plurality of dielectric materials having a length greater than that of the second transmission lines. Of course, the coupling portion may also be a step-like metal plate formed by connecting a plurality of metal materials having a length greater than that of the second transmission lines.

The phase shifter of the present invention controls the area of each of the second transmission lines shielded by the coupling portion, such that after the coupling portion that shields different areas of the second transmission lines couples the signal received by the second transmission lines, the second transmission lines output signals with different phases. In addition, the phase of the signal output by each of the second transmission lines is changed by moving the coupling portion.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first embodiment of the present invention;

FIG. 2 is another schematic view of the first embodiment of the present invention; and

FIG. 3 is a schematic view of a second embodiment of the present invention.

### DETAILED DESCRIPTION OF THE INVENTION

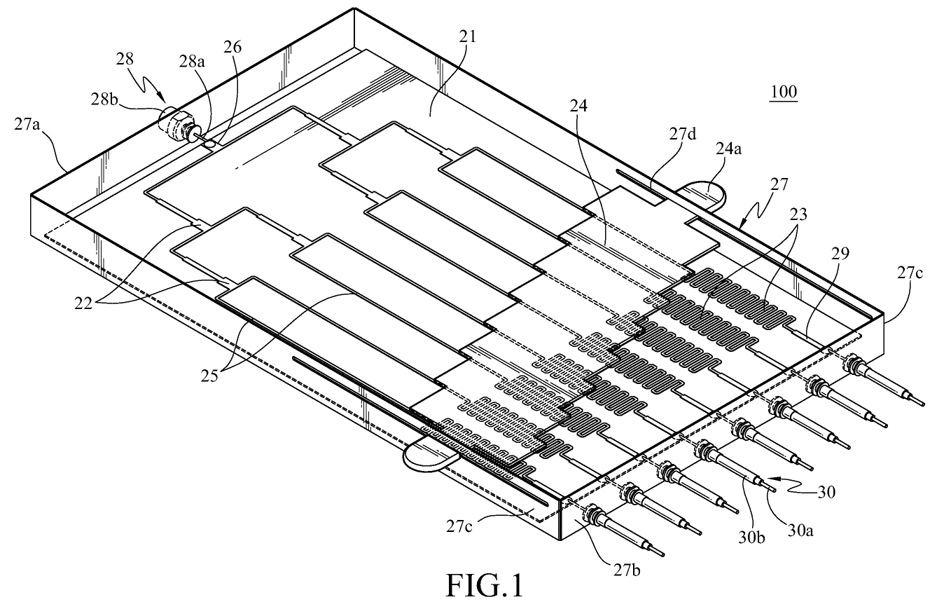

FIG. 1 is a schematic view of a first embodiment of the present invention. Referring to FIG. 1, the phase shifter 100 includes a substrate 21, a plurality of power distribution units 22, a plurality of second transmission lines 23, a coupling portion 24, and a plurality of output portions 29.

The substrate 21 is formed with a plurality of first transmission lines 25 and an input portion 26, in which the first transmission lines 25 transmit a signal fed in by the input portion 26. The phase shifter 100 is disposed inside a case 27. The case 27 includes a signal feed-in portion 28 for feeding the signal into the input portion 26. Further, the signal feed-in portion 28 penetrates a side surface 27a of the case 27 and is connected to the substrate 21. The signal feed-in portion 28 has an inner signal line 28a and an outer wrapping metal 28b, in which the outer wrapping metal 28b is connected to the side surface 27a of the case 27, and the inner signal line 28a is connected to the input portion 26 on the substrate 21. The power distribution units 22 are electrically connected to the first transmission lines 25, so as to assign the signal received by the input portion 26 to the first transmission lines 25 for transmission.

The second transmission lines 23 each has a first end electrically connected to one of the first transmission lines 25, and a second end electrically connected to one of the output portions 29 correspondingly. Each of the output portions 29 receives the signal output by the corresponding second transmission line 23. The second transmission lines 23, having the same length and arranged in parallel, are formed on the substrate 21 with an equal spacing from the output portions 29. The case 27 further includes a plurality of signal feed-out portions 30 for receiving and feeding out the signal transmitted by the output portions 29. The signal feed-out portions 30 penetrate another side surface 27b opposite to the side surface 27a of the case 27 and are connected to the substrate 21. Each of the signal feed-out portions 30 has an inner signal line 30a and an outer wrapping metal 30b, in which the outer wrapping metal 30b is connected to the side surface 27b of the case 27, and the inner signal line 30a is connected to one of the output portions 29 on the substrate 21. The signal feed-out portions 30 feed out the signal through the output portions 29. Each of the second transmission lines 23 is a serpentine metal line, and of course, may be a rectangular metal line or in other geometrical shapes.

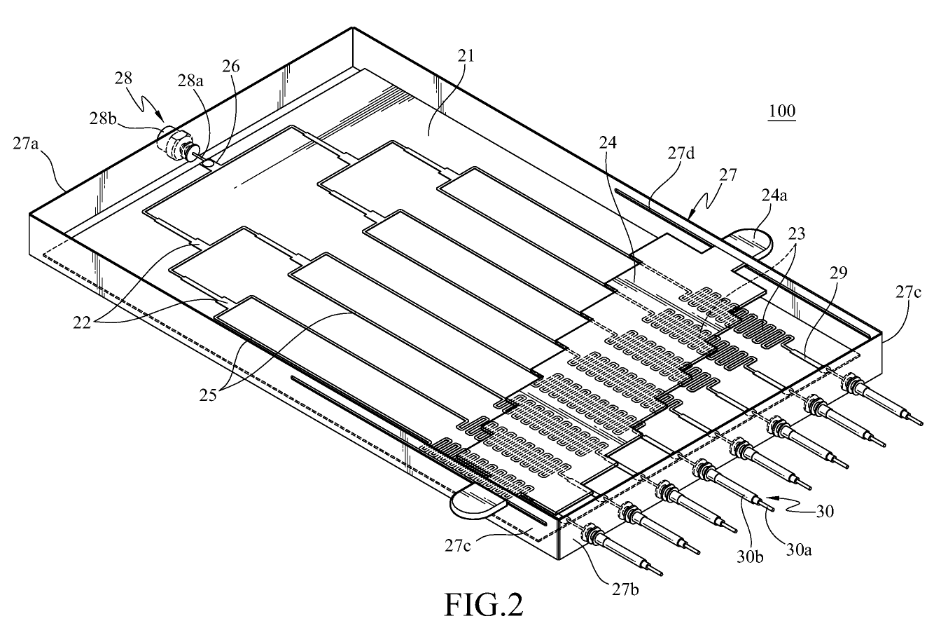

The coupling portion 24 has two movable portions 24a perpendicular to two sides of the coupling portion 24 respectively. The two movable portions 24a penetrate and are exposed out of two openings 27d in two side surfaces 27c of the case 27. The coupling portion 24 is driven to move through the two movable portions 24a exposed out of the two openings 27d. In addition, the coupling portion 24, disposed corresponding to and moving relative to the second transmission lines 23 to change an area of the second transmission lines 23 shielded by the coupling portion 24, is used for coupling the signal received by each of the second transmission lines 23, so as to change the phase of the signal transmitted by each of the second transmission lines 23. FIG. 2 is another schematic view of the first embodiment of the present invention. Referring to FIGS. 2 and 1, the position on each of the second transmission lines 23 shielded by the coupling portion 24 is changed, so the shielded area of each second transmission line 23 is different. Therefore, in FIGS. 1 and 2, the phase of the signal output by each of the second transmission lines is different.

The coupling portion 24 is a step-like dielectric plate formed by connecting a plurality of dielectric materials having a length greater than that of the second transmission lines 23. Of course, the coupling portion 24 may also be a step-like metal plate formed by connecting a plurality of metal materials having a length greater than that of the second transmission lines 23. The coupling portion 24 has two movable portions 24a perpendicular to two sides of the coupling portion 24. In addition, the two movable portions 24a penetrate and are exposed out of two openings 27d in two side surfaces 27c of the case 27.

In the phase shifter 100 of the present invention, a signal is fed by the signal feed-in portion 28 into the input portion 26 on the substrate 21, and the energy of the signal is uniformly distributed to the plurality of first transmission lines 25 through the plurality of power distribution units 22. When the signal on each of the first transmission lines 25 is transmitted to one of the second transmission lines 23 correspondingly, the coupling portion 24 is driven to move through the control of the two movable portions 24a, so as to shield different areas of the second transmission lines 23. As such, the coupling portion 24 that shields different areas of the second transmission lines 23 couples the signal received by each of the second transmission lines 23, changes the phase of the signal, and transmits the signal to each of the output portions 29. Afterward, the signal is fed out for transmission by each of the signal feed-out portions 30 corresponding to each of the output portions 29. Thereby, the phase angle of the signal output by each of the output portions 29 differs from one another. Further, in the phase shifter 100 of the present invention, the position on each of the second transmission lines 23 shielded by the coupling portion 24 is changed by moving the coupling portion 24, so the shielded area of each second transmission line 23 is different, and thus the phase of the signal output by each of the output portions 29 is changed accordingly.

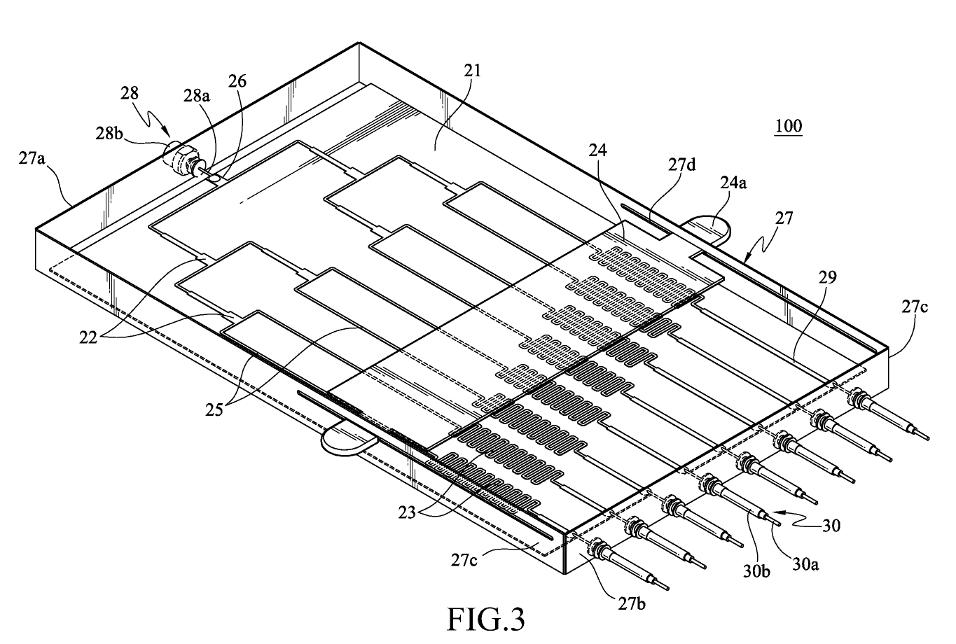

FIG. 3 is a schematic view of a second embodiment of the present invention. Referring to FIG. 3, the structure of the phase shifter 100 of this embodiment has been disclosed in the first embodiment, so the same parts can be known by comparison and will not be repeated herein again. This embodiment is characterized in the following aspects. The second transmission lines 23, having the same length and arranged step-like, are formed on the substrate 21 with a progressive spacing from the output portions 29. Besides, the coupling portion 24 is a rectangular dielectric plate formed by connecting a plurality of dielectric materials having a length greater than that of the second transmission lines 23. Of course, the coupling portion 24 may also be a rectangular metal plate formed by connecting a plurality of metal materials having a length greater than that of the second transmission lines 23.

What is claimed is:

1. A phase shifter, comprising:
a substrate, formed with a plurality of first transmission lines and an input portion, wherein the first transmission lines are respectively coupled to the input portion, for transmitting a signal received by the input portion;
a plurality of second transmission lines, formed on the substrate, and each having a first end electrically connected to one of the first transmission lines correspondingly;
a coupling portion, disposed corresponding to and moving relative to the second transmission lines to change an area of the second transmission lines shielded by the coupling portion, used for coupling the signal received by each of the second transmission lines, so as to change the phase of the signal transmitted by each of the second transmission lines; and
a plurality of output portions, each electrically connected to a second end of each of the second transmission lines, for receiving the signal output by the corresponding second transmission line.

2. The phase shifter as claimed in claim 1, wherein each of the second transmission lines is a serpentine metal line or a rectangular metal line.

3. The phase shifter as claimed in claim 1, wherein the phase shifter comprises a plurality of power distribution units electrically connected to the plurality of first transmission lines, so as to assign the signal received by the input portion to the first transmission lines for transmission.

4. The phase shifter as claimed in claim 1, wherein the second transmission lines, having the same length and arranged in parallel, are formed on the substrate with an equal spacing from the output portions.

5. The phase shifter as claimed in claim 4, wherein the coupling portion is a step-like dielectric plate formed by connecting a plurality of dielectric materials having a length greater than that of the second transmission lines.

6. The phase shifter as claimed in claim 4, wherein the coupling portion is a step-like metal plate formed by connecting a plurality of metal materials having a length greater than that of the second transmission lines.

7. The phase shifter as claimed in claim 1, wherein the second transmission lines, having the same length and arranged step-like, are formed on the substrate with a progressive spacing from the output portions.

8. The phase shifter as claimed in claim 7, wherein the coupling portion is a rectangular dielectric plate formed by connecting a plurality of dielectric materials having a length greater than that of the second transmission lines.

9. The phase shifter as claimed in claim 7, wherein the coupling portion is a rectangular metal plate formed by connecting a plurality of metal materials having a length greater than that of the second transmission lines.

10. The phase shifter as claimed in claim 1, wherein the phase shifter is disposed in a case.

11. The phase shifter as claimed in claim 10, wherein the case comprises a signal feed-in portion, for feeding the signal into the input portion.

12. The phase shifter as claimed in claim 10, wherein the case comprises a plurality of signal feed-out portions, for receiving and feeding out the signal transmitted by the output portions.

13. The phase shifter as claimed in claim 10, wherein the coupling portion comprises two movable portions perpendicular to two sides of the coupling portion respectively.

14. The phase shifter as claimed in claim 13, wherein the case comprises two openings, for the penetration and exposure of the two movable portions.
